(19) United States
(12) Patent Application Publication
(10) Pub. No.: US 2021/0027147 A1
(43) Pub. Date: Jan. 28, 2021

(54) FORWARD PROPAGATION OF SECONDARY OBJECTIVE FOR DEEP LEARNING

(71) Applicant: D5AI LLC, Maitland, FL (US)

(72) Inventor: James K. Baker, Maitland, FL (US)

(21) Appl. No.: 16/619,346

(22) PCT Filed: Jun. 28, 2019
(86) PCT No.: PCT/US19/39703

§ 371 Date: Dec. 4, 2019

(51) Int. Cl. G06N 3/04; G06N 3/08; G06K 9/62

(52) U.S. Cl. CPC G06N 3/0481; G06N 3/084; G06K 9/6257; G06K 9/6264; G06N 3/0472

(57) ABSTRACT

Computer systems and methods optimize a secondary objective function in the training of a multi-layer feed-forward neural network in which the secondary objective is a function of the partial derivatives of the primary objective function. Optimizing this secondary objective function comprises computing derivatives of functions of the partial derivatives computed during the back-propagation computation in a third stage of computation before the parameter update. This third stage of computation proceeds in the reverse direction from the direction of the back propagation computation. That is, the third stage of computation proceeds forwards through the network, computing derivatives of the secondary objective function based on the chain rule of calculus. The secondary objective may be used to make the neural network more robust against deviations in the input values from their normal values.

### PRIORITY CLAIM

The present application claims priority to U.S. provisional patent application Ser. No. 62/694,206, filed Jul. 5, 2018, having the same inventor and title as indicated above, and which is incorporated herein by reference in its entirety.

### BACKGROUND

Training a machine learning system often relies on making an iterative update to a set of trainable parameters to optimize an objective function. This iterative optimization often involves the gradient of an objective function, that is, computing the partial derivative of the objective function with respect to each of the trainable parameters. For example, in a well-known procedure for training a feed-forward multi-layer neural net work, a parameter update is computed for each minibatch of training data based on estimates of the partial derivatives of the objective function with respect to the connection weights and node biases. The computation is performed in two stages: (1) a feed forward computation to compute the activation value of each node in the network; and (2) a back propagation computation that computes the partial derivative of the objective function with respect each connection weight and each node bias. This backwards computation is based on the chain rule of calculus for computing the derivative of a function by proceeding backwards through the network.

### SUMMARY

The invention described herein provides, in one general aspect, a method for optimizing a secondary objective function in the training of a multi-layer feed-forward neural network in which the secondary objective is a function of the partial derivatives of the primary objective function. Optimizing this secondary objective function comprises, according to various embodiments, computing derivatives of functions of the partial derivatives computed during the back-propagation computation in a third stage of computation before the parameter update. This third stage of computation proceeds in the reverse direction from the direction of the back propagation computation. That is, the third stage of computation proceeds forwards through the network, computing derivatives of the secondary objective function based on the chain rule of calculus.

The secondary objective may be used to make the neural network more robust against deviations in the input values from their normal values. These and other benefits of the present invention will be apparent from the description that follows.

### FIGURES

Various embodiments of the present invention are described herein by way of example in connection with the following figures, wherein:

FIGS. 1 and 2 collectively illustrate a process, according to various embodiments of the present invention, for optimizing a secondary objective that is a function of the partial derivatives of the primary objective function being optimized in the training of a deep neural network;

FIG. 3 illustrates an example deep neural network; and

FIG. 4 is a diagram of a computer system for implementing the process shown in FIGS. 1 and 2 according to various embodiments of the present invention.

### DETAILED DESCRIPTION

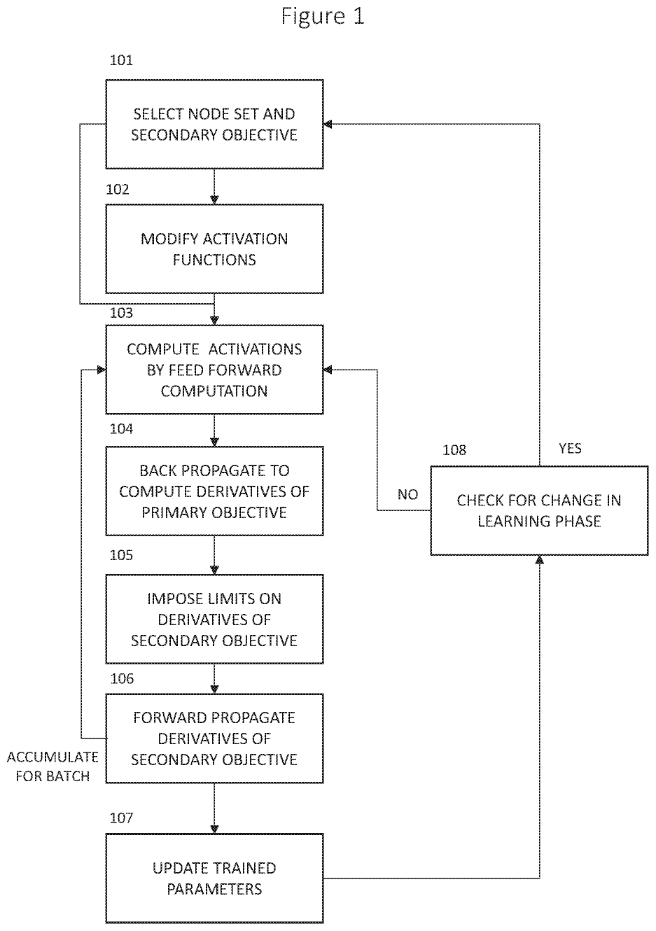

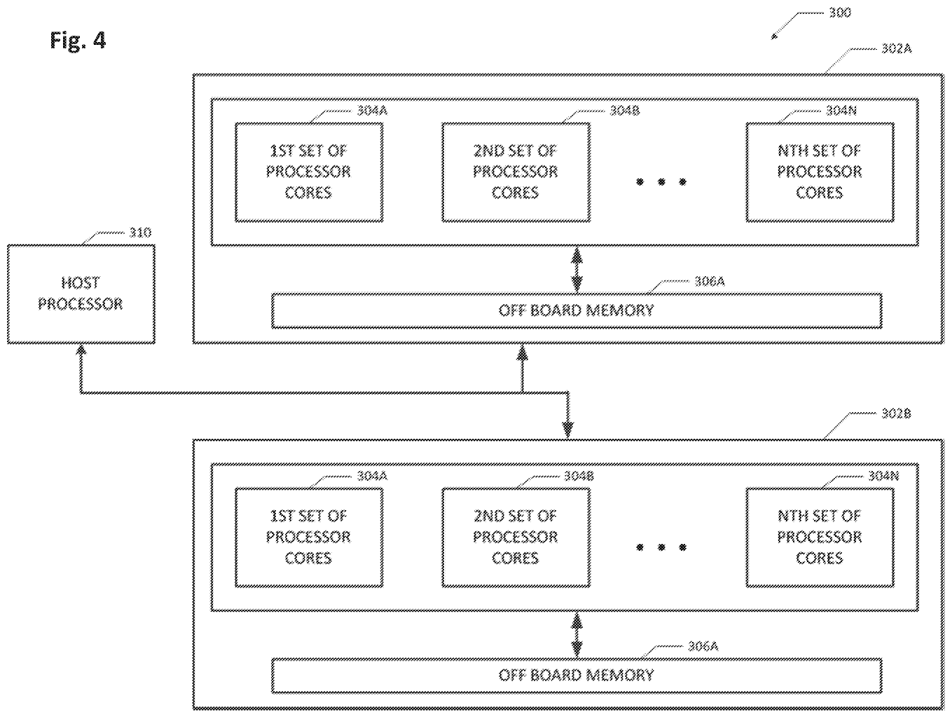

FIG. 1 is a flow chart of an illustrative embodiment of the invention disclosed herein for optimizing a secondary objective that is a function of the partial derivatives of the primary objective function being optimized in the training of a deep neural network. The process of FIG. 1 may be implemented with a computer system, as described in more detail below in connection with FIG. 4. At Step 101 of FIG. 1, the computer system selects a set of nodes of the deep neural network and a secondary objective function to be optimized. The secondary objective preferably is a function of the partial derivatives of a specified primary objective with respect to the values of the learned parameters and other attributes of the deep neural network. The primary objective may be associated with a classification task, with a prediction or regression task, or with some other pattern analysis or generation task (e.g., data generation or synthesis).

In this discussion, a neural network, such as shown in FIG. 4, comprises a network of nodes organized into layers, including a layer of input layer nodes, zero or more inner layers that each have one or more nodes, and a layer of output layer nodes. The neural network is said to be a deep neural network if there are two or more inner layers, as shown in the example of FIG. 4. There is an input layer node in the input layer associated with each input variable and an output layer node in the output layer associated with each output variable. An inner layer may also be called a “hidden” layer. A given node in the output layer or in an inner layer is connected to one or more nodes in lower layers by means of a directed arc from the node in the lower layer to the given higher layer node (shown as arrows between nodes in FIG. 4). A directed arc may be associated with a trainable parameter, called its weight, which represents the strength of the connection from the lower node to the given higher node.

Each node in the output layer or in an inner layer is also associated with a function, called its activation function. The activation function of a node computes a value based on the values received from lower level connected nodes and the associated connection weights. For example, the activation value of a node for a data item might be determined by a formula such as:

A(x₁, x₂, . . . , xₖ, w₁, w₂, . . . , wₖ)=f(Σᵢ₌₁^{k}wᵢxᵢ+b)

where the values xᵢ are the activation values of the connected lower level nodes, and the values wᵢ are the respective connection weights, and b is an additional learned parameter associated with the node, called its bias, i.e., a constant independent of the current data item. In this example, the function A=f(x) is called the activation function.

An example of an activation function A=f(x) is the sigmoid function, defined by A=1/(1+exp(−x)). Another example is the function defined by A=max(0, x). A node with this activation function is referred to as a rectified linear unit (ReLU). A third example is a piecewise linear function defined by A=f(x)=min(1, max (0, x)). This activation function is sometimes called a “hard sigmoid.” A fourth example is the step function defined by A=f(x)=0 if x≤0, 1 if x>0. This step function is also called the Perceptron function, after the name of the original simplified artificial model of a neuron.

For any given data item, the activation of each input node is equal to the value for the given data item of the input variable that corresponds to the node.

The activation value of each of the other nodes in the network for the given item is computed by a process called feed forward activation, which proceeds layer-by-layer through the network, computing the input to each node based on the activations of lower level nodes and their connection weights, and computes the output of the node by applying the node's activation function to the computed input.

A neural network learns to approximate the desired set of output values for each specified set of input values. The neural network is trained by an iterative procedure for updating the learned parameters, that is, the connection weights and biases. The learned parameters may be updated by a process called stochastic gradient descent. In stochastic gradient descent, an estimate is made of the gradient of the objective based on a set of training data examples, called a minibatch. The objective function is some measure of the accuracy of the output computed by the neural network, that is, some measure of how close the computed outputs for each data item are to the desired outputs for that data item. Typically, there is only one update of the learned parameters for each minibatch.

However, the objective function is measured for each individual data item, and the partial derivatives of the objective for each data item are computed by a process called back propagation. Back propagation proceeds backwards through the network, applying the chain rule of calculus to compute the partial derivatives. For each given node, the partial derivative of the objective with respect to the output activation value of the node is a weighted sum of the partial derivatives of the objective with respect to higher level nodes to which the given node is connected. The derivative for each higher level node passed to the computation for the lower level node is evaluated with respect to the input to the higher level node. For the purpose of this discussion, the objective function that is to be optimized in the training of a neural network is called the primary objective function.

Returning to step 101, a subset of the nodes of the neural network are selected. The selected node subset may comprise, for example: (i) a node or nodes on a single inner layer of the neural network; (ii) a node or nodes on the input layer; or (iii) nodes on two or more different layers of the neural network (e.g., two or more inner layer or one or more inner layers plus the input layer). Also, in an illustrative embodiment, the secondary objective function (as opposed to the primary objective function) to be optimized is a function of the values of the partial derivatives of the primary objective with respect to the activation value of each of the selected nodes. As an example, the primary objective may be the error cost function or loss function in a classification task. In this illustrative example, the selected set of nodes may be the set of nodes in the input layer, with the neural network being a feed forward neural network. On an item of training data, the activations of the nodes in the network are computed by a feed forward computation (step 103 in FIG. 1) and the partial derivatives of the primary objective (e.g., the error cost function) are computed by a back propagation computation (step 104 of FIG. 1). These feed forward and back propagation computations are well-known to those skilled in the art of training deep neural networks.

In various embodiments of the present invention, the back propagation computation is extended backwards an additional step that is not used in normal training of a neural network. This extra step of back propagation, at step 106 of FIG. 1, computes the partial derivatives of the primary objective with respect to the input values, which are also the activation values for the nodes in the input layer. One implementation of this extra step of back propagation is to give each input node a dummy bias, e.g., setting the value of the bias to zero. Generally, without changing any code, an existing back propagation procedure can compute the partial derivative of the primary objective with respect to the bias parameter associated with each input node, which is the same as the partial derivative of the primary objective with respect to the activation value of the associated input node. The value of the dummy bias, however, is not updated, but is left as zero. Any other equivalent computation may be used instead to compute the partial derivative of the primary objective with respect to the activation value of each input node.

In this illustrative embodiment, the selected nodes are the input layer nodes and the secondary objective is a norm of the vector of partial derivatives of the primary objective in which there is one element of the vector for each input layer node in the network. The norm may be, for example, the L2 norm. The mathematical definition of the L2 norm is the square root of the sum of the squares of the values of the elements of the vector. In this case, the L2 norm is the square root of the sum of the squares of the values of the partial derivatives of the primary objective with respect to the activation values of the input nodes. For numerical convenience, in some embodiments and in this discussion, the L2 norm is represented instead by ½ times the sum of the squares of the partial derivatives of the primary objective with respect to the activation values of the input nodes, that is without taking the square root. As another example, the secondary objective may be the L1 norm of the vector of partial derivatives of the primary objective with respect to the inputs. The L1 norm of a vector is the sum of the absolute values of the elements of the vector.

This illustrative example of a secondary objective may be used to make the neural network more robust against deviations in the input values from their normal values. Decreasing either of these norms of the derivatives of the primary objective will decrease the sensitivity of the classification or regression computed by the neural network to changes in the input values, whether those changes are caused by random perturbations or by deliberate adversarial action.

As another example, some set of nodes other than input layer nodes may be selected at step 101, such as a node(s) on one or more inner layers. For example, a set of inner layer nodes may be selected because they represent features of particular interest, such phonemes in speech; eyes, mouth, and nose in an image of a face; or proper nouns in a text document. As another example, a set of inner layer nodes may be selected because it has been empirically discovered that their levels of activation influence the success and robustness of the task of the network; for example, such a selection criterion might be applied in the loop back from step 108 to step 101 in FIG. 1.

In any of these examples of a selected set of nodes with nodes from inner layers, a vector norm over the vector of partial derivatives of the primary objective with respect to the activation values of the selected nodes may be applied as described above for a selected set of input nodes.

In some embodiments, when a node from an inner layer is selected, the partial derivative of the primary objective to be associated with selected node is the partial derivative of the primary objective with respect to the output activation of the node. In other embodiments, the partial derivative to be used in the norm may be the partial derivative of the primary objective with respect to the input to the activation function. Some embodiments may use a mixture of the two choices. The extra choice that exists for a set of inner layer nodes does not exist for an input node as previously discussed, since for an input node the output of the node is the same as the input.

The selection of a secondary objective and of a set of nodes to participate in that secondary objective may be specified by a system developer or may be controlled by a separate machine learning system called a learning coach. A learning coach is a separate machine learning system that learns to control and guide the learning of a primary learning system. For example, the learning coach itself uses machine learning to help a “student” machine learning system, e.g., the neural network trained according to the method of FIG. 1. For example, by monitoring the student machine learning system, the learning coach can learn (through machine learning techniques) “hyperparameters” for the student machine learning system that control the machine learning process for the student learning system. For example, in the case where the student machine learning system uses a deep neural network (DNN), the learned hyperparameters can include the minibatch size M, the learning rate the regularization parameter k, and/or the momentum parameter μ. Also, one set of learned hyperparameters could be used to determine all of the weights of the student machine learning system's network, or customized learned hypermeters can be used for different weights in the network. For example, each weight (or other trainable parameter) of the student learning system could have its own set of customized learned hyperparameters that are learned by the learning system coach. Also, the learning coach may select the secondary objective and/or the set of nodes to participate in the secondary objective training described in connection with FIG. 1.

Additionally or in lieu of learning the hyperparameters or the other enhancements/updates described above, the learning coach could determine structural modifications for the student learning system architecture. For example, where the student learning system uses a DNN, the machine learning coach can modify the structure of the DNN, such as by adding or deleting layers and/or by adding or deleting nodes in layers. Additionally, the student learning system might include an ensemble of machine learning system. The learning coach in such a scenario could control the data flow to the various machine learning systems and/or add members to the ensemble.

The student learning system(s) and machine learning coach preferably operate in parallel. That is, the machine learning coach observes the student learning system(s) while the student learning system(s) is/are in the learning process and the machine learning coach makes its changes to the student learning system(s) (e.g., hyperparameters, structural modifications, etc.) while the student learning system(s) is/are in the learning process. The learning coach and the student(s) may be the same or different types of machine learning architectures.

The learning coach can have an objective function distinct from the primary and secondary objectives of the student learning system. For example, the primary and secondary objective of the student learning system may be as described herein, while the learning coach makes structural modifications to the student learning system to optimize some combination of the cost of errors and the cost of performing the computation. The learning coach can also make modifications to the student learning system, especially additions, to improve its capabilities while guaranteeing that there will be no degradation in performance. More details about such learning coaches are explained in the following published international applications, which are incorporated herein in their entirety: WO 2018/063840 A1, published Apr. 5, 2018, entitled “LEARNING COACH FOR MACHINE LEARNING SYSTEM”; and WO 2018/175098 A1, published Sep. 27, 2018, entitled “LEARNING COACH FOR MACHINE LEARNING SYSTEM.”

In some embodiments, a secondary objective of a different type than a norm of the component partial derivatives may be specified at step 101. For example, a learning coach may specify a target value for each partial derivative for a selected set of nodes and the secondary objective may be an error cost function based on the deviation of the actual value of each partial derivative from its target value. This type of objective is often used for the primary objective and is well-known to those skilled in the art of training neural networks.

At Step 102 of FIG. 1, which is optional, the computer system modifies the activation functions of one or more nodes. In a preferred embodiment, the modification in an activation function is designed to make certain aspects of the partial derivatives that are to be measured by a secondary objective more prominent. For example, for a secondary objective that seeks to minimize a norm of the vector of partial derivatives of the primary objective on a set of nodes, the modification to an activation function may smooth out an activation function such that a large sudden change in the activation function as a function of its input may be spread out over a broader region of input values so that the effect of the large change in the activation function will be observable for a wider range of input values to the activation function. This change in the activation function may help make the potential influence of the large change in the activation function observable in the norm computed in the secondary objective function for a greater variety of data items.

As an illustrative example, let the activation function for a node be the sigmoid function, defined by sigmoid(x)=1/(1+exp(−x)). The sigmoid function may be modified by adding a hyperparameter T, called temperature and the parametric sigmoid function may be defined by sigmoid(x;T)=1/(1+exp(−x/T)). The normal sigmoid function is equivalent to a parametric sigmoid function with the value of the hyperparameter T=1. The activation function may be changed to a smoother activation function by changing the hyperparameter T to a value greater than 1.

As another illustrative example, any activation function may be smoothed by convolving it with a non-negative function that is symmetric around zero, such as g(x)=exp(−x²/T).

The value of the hyperparameter T may be set by the system developer, may vary based on a fixed schedule, or may be controlled by a learning coach. The amount of smoothing may depend on the phase of the learning process, as determined by step 108.

In addition, at step 102 the computer system may modify each activation function so that its derivative is bounded away from zero. For example, at step 102 the computer system may add a linear term to each activation function so that A(x)=f(x) becomes A(x)=f(x)+s*x, where s>0. The need for this modification will be apparent in the upcoming discussion of step 106.

For each item of training data, at step 103 the computer system computes the activation value of each node in the network with a feed forward computation that is well-known to those skilled in the art of training deep neural networks. In one preferred embodiment, this feed forward computation is done using the original, unmodified activation functions. In some embodiments, this feed forward computation is done using the modified activation function, for consistency with step 106.

For each item of training data, at step 104 the computer system computes the partial derivative of the primary objective with respect to each node in the network and each learned parameter, using the back propagation computation, which is well-known to those skilled in the art of training deep neural networks. In some embodiments, at step 104 the computer system adds an extra step to the back propagation computation, computing the derivatives of the primary objective with respect to the value of each input data variable, that is, with respect to the activation value of each node in the input layer. This extra step is necessary so that the partial derivatives with respect to one or more input layer nodes can be included in a secondary objective. In a preferred embodiment, there are two back propagation computations in step 104: a first computation using the original unsmoothed activation functions, which is used for computing the updates to the learned parameters; and a second computation using the smoothed activation functions. In this embodiment, the second back propagation computation uses the smoothed activation functions and the partial derivatives that it computes are used in step 106. In another embodiment, only the partial derivatives of the smoothed form of the activation function are computed and used both for the updates of the learned parameters and to supply partial derivatives of the secondary objective for step 106. In any of these embodiments, step 106 uses the smoothed activation functions for computing the forward propagation of the derivatives of the secondary objective. In an embodiment in which step 102 is skipped, the unmodified activation functions are used for both the updates of the learned parameters and to supply partial derivatives of the secondary objective in step 106.

At Step 105, the computer system sets limits on the values computed by step 106. This step will be explained in more detail below.

At Step 106, the computer system computes partial derivatives of the secondary objective, which is itself a function of partial derivatives of the primary objective. Because the partial derivatives of the primary objective are computed by back propagation, that is, by going backwards through the network, partial derivatives of the secondary objective must be computed in the opposite direction, that is, going forwards through the network.

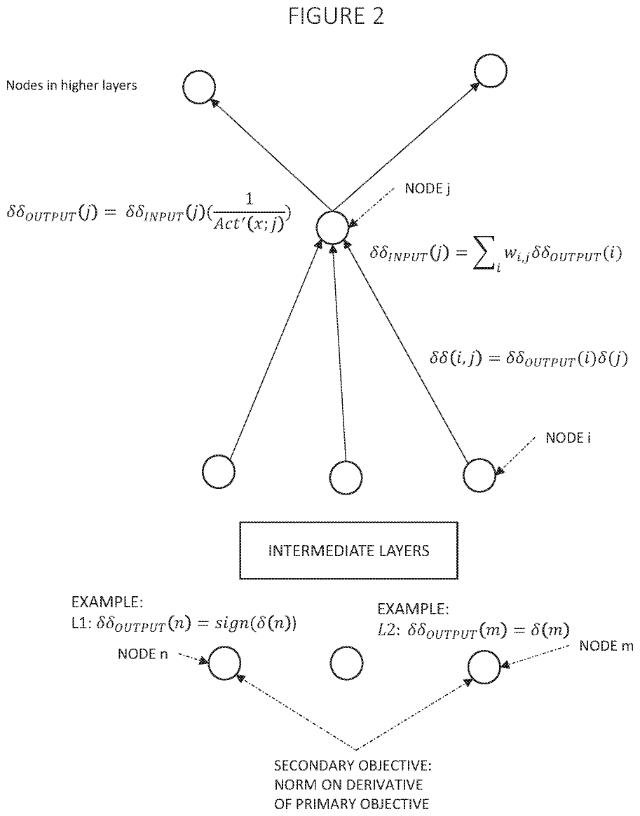

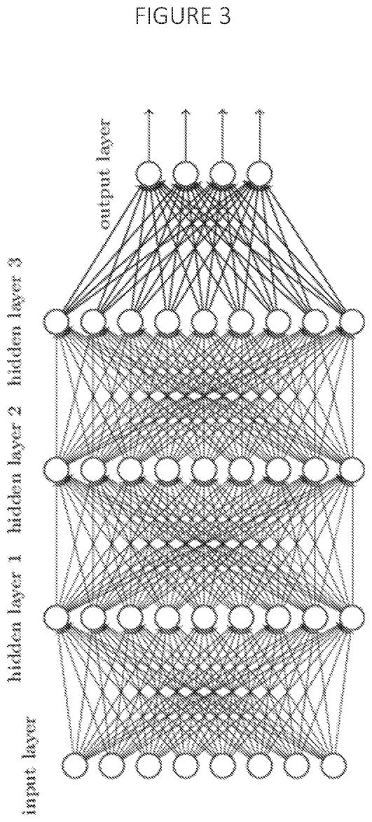

Like back propagation, the computation done by step 106 is based on the chain rule of calculus and is shown in more detail in FIG. 2. FIG. 2 shows the start of the computation of the partial derivative of the secondary objective, at NODE m or NODE n. FIG. 2 then shows the detail of the forward propagation of the partial derivatives of the secondary objective through a typical node, NODE j. The function δ(k) represents the value of the derivative of the primary objective with respect to the output activation value of node k, as computed at step 104. Functions with two deltas, denoted δδ( ), are used to represent various partial derivatives of the secondary objective. For example, δδ_{INPUT}(j) represents the partial derivative of the secondary objective with respect to the input to NODE j and δδ_{OUTPUT}(j) represents the partial derivative of the secondary objective with respect to the output activation value of NODE j. Finally, δδ(i, j) represents the partial derivative of the secondary objective with respect to the connection weight from NODE i to NODE j.

Step 106 begins the process of computing the partial derivatives of the secondary objective with each node in the set of nodes selected in step 101. The formula for starting the computation depends on the type of objective function used for the secondary objective. If the objective is to minimize ½ the sum of the squares of the derivatives of the primary objective over a set of nodes containing NODE m (the simplified L2 norm), then δδ_{OUTPUT}(m)=δ(m). If the objective is to minimize the sum of the absolute values of the derivatives of the primary objective over a set of nodes containing NODE n, then δδ_{OUTPUT}(n)=sign(δ(n)). The function sign(x) is defined by sign(x)=−1 for x<0 and sign(x)=1 for x≥0. These two examples are shown in the bottom part of FIG. 2.

The rest of FIG. 2 shows the forward propagation of the derivatives of the secondary objective from nodes for which it has already been computed, such as NODE i, through NODE j and then on to nodes in higher layers. NODE i may be an initial node, such as NODE m or NODE n, or there may be intermediate layers between the initial nodes and NODE i. In any case, FIG. 2 shows the computation at a stage at which δδ_{OUTPUT}(i) has already been computed, and the value of δδ_{OUTPUT}(k) has also been computed for all lower layer nodes k that are connected to NODE j.

As shown in FIG. 2, at step 106 the computer system then computes the partial derivative of the secondary objective with respect to the connection weight from NODE i to NODE j by δδ(i, j)=δδ_{OUTPUT}(i)δ(j). This estimate of the partial derivative of the secondary objective with respect to the connection weight for the connection from NODE i to NODE j will be accumulated over a batch of data and then will be used as a term in computing the update to this weight parameter. Note that the batch size for computing estimates of the partial derivatives of the secondary objective may be different from the mini-batch size used for accumulating estimates of the partial derivatives for the primary objective. For example, it may be an integer multiple of the mini-batch size for updating the learned parameters based on the primary objective, as explained in association with step 107. When the learned parameters are being updated in part based on the secondary objective, there is an additional term in the update value. The additional term is the estimated negative gradient of the secondary objective multiplied by its learning rate.

As shown in FIG. 2, at step 106 the computer system then computes the partial derivative of the secondary objective with respect to the input to NODE j by δδ_{INPUT}(j)=Σᵢw_{i,j}δδ_{OUTPUT}(i). Note that the notation Act′(x; j) in FIG. 2 represents the derivative of the modified activation function for NODE j, evaluated at the point x that was the input value to NODE j computed during the feed forward computation in step 103. That is, in some embodiments, it is a somewhat ad hoc mix of a computation using values computed with the unmodified activation functions within a computation that uses the modified activation functions.

As shown in FIG. 2, at step 1 the computer system computes the partial derivative of the secondary objective with respect to the output of NODE j by

$${δδ}_{OUTPUT} ( j ) = {δδ}_{INPUT} ( j ) ( \frac{1}{{Act}^{′} ( x ; j )} ) . {δδ}_{OUTPUT} ( j ) requires$$

Notice that the computation of a division by the derivative of the activation function of NODE j. For the unmodified activation function, this computation might require a division by zero, which is why at step 102 the computer system can modify each activation function to be bounded away from zero.

However, bounding the derivative of each activation function away from zero may not be sufficient because the estimated partial derivatives of the secondary objective might still grow very large in magnitude. For example, although the value s in the linear term added in step 102 is greater than zero, it should not be so large that it makes a substantial change in the activation function. Thus, s may be small and 1/s may be large.

Preferably at step 105 the computer system imposes additional constraints to prevent the values computed in the forward computation at step 106 from growing too large in magnitude. For example, step 105 may impose a limit on the number of layers that a derivative of the secondary function may be propagated forward. In order to estimate updates for all the learned parameters, the back propagation of derivatives of the primary objective must be computed backwards through all the inner layers of the neural network. However, there is no such requirement on the forward propagation of derivatives of the secondary objective at step 106.

The system developer may set a fixed limit in step 105 on the number of layers to forward propagate any derivative of the secondary objective, or may set a stopping criterion on the forward computation. In some embodiments, a learning coach may dynamically adjust hyperparameters controlling a stopping criterion for the forward propagation of the derivatives of the secondary objective.

Instead, or in addition, some embodiments at step 105 may impose a limit on the maximum magnitude that may be assigned to a derivative of the secondary objective. This limit may be a fixed numerical value that is the same for all nodes in the network, or it may be individualized to each node. In some embodiments, this limit may be computed dynamically. For example, each derivative of the secondary objective may be limited to have a magnitude no greater than r times the corresponding derivative of the primary objective function, where preferably, 0<r<1. The value of r may be fixed; it may be changed by a predetermined schedule; or it may be a hyperparameter dynamically controlled by a learning coach. Having a value of r<1 helps prevent the term from the secondary objective from overwhelming the term from the primary objective in the parameter update computation in step 107.

Any of the limits discussed in the preceding paragraphs may be imposed as maximum allowed values. That is, any value greater than the limit is changed to the limit value. Alternately, a limit may be used to determine a scale factor. Then each derivative in a given layer is divided by the scale factor, so that the ratios of respective derivative values in the same layer is maintained.

Returning in FIG. 1, at Step 107, the computer system updates the trained parameters for the neural network, such as the connection weights and biases. Step 107 may also use other hyperparameters that help control the contribution to the updates from the secondary objective compared to contributions from the primary objective. For example, step 107 may use a lower learning rate for the term from the secondary function than for the term from the primary function.

At Steps 103 to 107 of FIG. 1, the computer system may train the neural network by an iterative process called stochastic gradient descent, which is well-known to those skilled in the art of training deep neural networks. In stochastic gradient descent, the training data items are grouped into batches called minibatches. For each data item, an estimate is made for the gradient of the objective based on the back propagation computation in step 104. The loop back from step 106 to step 103 is taken until this gradient update estimated from individual data items can be accumulated for all the data items in a minibatch.

Ignoring for the moment the contribution to the update from the secondary objective, this estimate of the gradient of the primary objective is multiplied by a number called the learning rate. Then all of the learned parameters are updated by changing them in the opposite or negative of the direction of the estimated gradient. The size of the step in the update is the product of the magnitude of the estimated gradient times the learning rate.

To incorporate the secondary objective, the updating of the trained parameters at step 107 may have additional hyperparameters and/or modify the process of stochastic gradient descent in several ways. In some embodiments, step 107 has a different learning rate for the secondary objective than for the primary objective. In addition, in an illustrative embodiment, at step 107 the computer system uses a larger minibatch for the secondary objective than for the primary objective. Preferably the minibatch size for the secondary objective is an integer multiple, say k, of the minibatch size for the primary objective. In this illustrative embodiment, step 107 only includes a term from the secondary objective once for every k minibatch updates associated with gradient of the primary objective. Thus, the influence of the secondary objective on the updates to the parameter is reduced by three successive multiplicative factors: (1) the factor r imposed in step 105; (2) the ratio of the learning rate for the secondary objective to the learning rate for the primary objective; and (3) the reciprocal of k, the number of primary objective minibatches per secondary minibatch.

In some embodiments, there may be an additional hyperparameter that controls the weight of the secondary objective relative to the primary objective based on other criteria. For example, this hyperparameter may be controlled as a form of regularization to lessen over fitting of the training data.

The hyperparameters determining these factors may be controlled by a learning coach and may vary from one phase of the learning process to another, as determined in step 108. At Step 108, the computer system checks for a change in the phase of the learning process. For example, in an illustrative embodiment, the hyperparameters may be controlled differently in three phases: (1) an early phase of learning, (2) a main learning phase, and (3) a final learning phase.

In an early phase of the learning process, smoothed activation functions may be used for both updating the learned parameters and for computing the derivatives of the secondary objective. In this early learning phase, the use of the smoothed activation functions for updating the learned parameters may help accelerate the learning process by preventing the activation function of a node from being in a portion of its range in which the magnitude of the partial derivative is small, such as for extreme positive and negative inputs for a sigmoid or for negative inputs for a rectified linear unit.

In this illustrative example, in the main learning phase the hyperparameters may be set to default values or may be adjusted according to a predetermined schedule. In a final learning phase, the learned parameters may be updated based on a primary objective computed with unmodified activation functions while the secondary objective is based on the smoothed activation functions. In another illustrative embodiment, the process illustrated in FIG. 1 is only applied in an extra phase of learning that is added after the regular learning process has reached some stopping criterion.

The changes in the hyperparameters may be controlled by a learning coach. A learning coach may determine the learning phase based on measurements of the activations and partial derivatives computed in feed forward and back propagation computations for a data item and also on comparisons across data items or across minibatches. A learning coach also may customize the values of the hyperparameters on a node-by-node basis.

In some embodiments, some of the hyperparameters used in step 102 are controlled for other purposes. For example, in some embodiments the regular activation function of some nodes may be a parametric sigmoid or some other parametric activation function with a hyperparameter like the temperature T in a parametric sigmoid function. Examples of the use of such a parametric activation function are discussed in published international application WO 2018/231708 A2, published Dec. 20, 2018 and entitled “ROBUST ANTI-ADVERSARIAL MACHINE LEARNING,” which is incorporated herein by reference in its entirety.

If there is no change in the phase of the learning process, step 108 returns control to step 103 unless a stopping criterion is met. A stopping criterion may be to detect convergence of the training process or a sustained interval of no improvement on a validation set. If there is a change in the phase of the learning process, control is returned to step 101.

Based on the above description, it is clear that embodiments of the present invention can be used to improve the operation of deep neural networks in a variety of applications. For example, embodiments of the present invention can improve deep neural networks used in recommender systems, speech recognition systems, and classification systems, including image and diagnostic classification systems, to name but a few examples.

FIG. 4 is a diagram of a computer system 300 that could be used to implement the embodiments described above, such as the process described in connection with FIGS. 1 and 2. The illustrated computer system 300 comprises multiple processor units 302A-B that Each processor unit 302A-B may comprise on-board memory (ROM or RAM) (not shown) and off-board memory 306A-B. The on-board memory may comprise primary, volatile and/or non-volatile, storage (e.g., storage directly accessible by the processor cores 304A-N). The off-board memory 306A-B may comprise secondary, non-volatile storage (e.g., storage that is not directly accessible by the processor cores 304A-N), such as ROM, HDDs, SSD, flash, etc. The processor cores 304A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 310 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 304 may train and/or implement different networks or subnetworks or components. For example, in one embodiment, the cores of the first processor unit 302A may implement the neural network and the second processor unit 302B may implement the learning coach. For example, the cores of the first processor unit 302A may train the neural network and perform the process described in connection with FIGS. 1 and 2, whereas the cores of the second processor unit 302B may learn, from implementation of the learning coach, the parameters for the neural network. Further, different sets of cores in the first processor unit 302A may be responsible for different subnetworks in the neural network or different ensemble members where the neural network comprises an ensemble. One or more host processors 310 may coordinate and control the processor units 302A-B.

In other embodiments, the system 100 could be implemented with one processor unit 302. In embodiments where there are multiple processor units, the processor units could be co-located or distributed. For example, the processor units 302 may be interconnected by data networks, such as a LAN, WAN, the Internet, etc., using suitable wired and/or wireless data communication links. Data may be shared between the various processing units 302 using suitable data links, such as data buses (preferably high-speed data buses) or network links (e.g., Ethernet).

The software for the various compute systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

In one general aspect, therefore, the present invention is directed to computer systems 300 and computer-implemented methods for improving a neural network. The neural network comprises: (i) an input layer comprising at least one input layer node; (ii) an output layer comprising at least one output layer node; and (iii) one or more inner layers between the input layer and the output layer, wherein each of the one or more inner layers comprise at least one inner layer node. The method comprises, for each of a plurality of training data examples: (a) in a feed forward computation through the neural network, computing, with the computer system, an activation value for each inner layer node of the neural network; (b) in a back-propagation computation through the neural network, computing, with the computer system, a partial derivative of a primary objective with respect to each inner layer node of the neural network; and (c) following the back-propagation computation, computing, with the computer system, a partial derivative of a secondary objective with respect to each node in a selected node subset of the neural network. In particular, the selected node subset comprises one or more nodes of the neural network and the secondary objective is function of one or more computed partial derivatives of the primary objective computed in the back-propagation computation. Still further, the partial derivatives of the secondary objective for the selected node subset are computed using a forward-propagation through the neural network. The method further comprises the step of updating, by the computer system, a learned parameter for the neural network based on, in part, the computed partial derivatives of the secondary objective.

In various implementations, the neural network comprises two or more inner layers between the input layer and the output layer, and each of the two or more inner layers comprises at least one inner layer node. Also, the neural network may be a feedforward neural network. In addition, the primary objective may be associated with a task selected from the group consisting of a classification task, a prediction task, a regression task, a pattern analysis task and a generation task. Still further, the secondary objective function ma be a function of the computed partial derivatives of the primary objective with respect to an activation value of each node of the selected node subset.

According to still further implementations, the selected node subset comprises at least one input layer node. In such circumstances, the step of computing the partial derivative of the primary objective with respect to each node of the one or more inner layers in the neural network may further comprise computing, with the computer system, a partial derivative of the primary objective with respect to activation values for the at least one input layer node in the selected node subset. Also, the step of updating the learned parameter may comprise updating, by the computer system, a learned parameter for the neural network based on, in part, the computed partial derivatives of the secondary objective with respect to the at least one input layer node in the selected node subset.

In addition, the step of computing the partial derivative of the primary objective with respect to the activation values for the at least one input layer node in the selected node subset may comprise assigning the at least one input layer node in the selected node subset an arbitrary bias value (which may be zero, for example), wherein the arbitrary bias value is used in computing the partial derivative of the primary objective with respect to the activation values for the at least one input layer node in the selected node subset.

In various implementations, the secondary objective is a norm (such as the L2 or L1 norm) of a vector of partial derivatives of the primary objective, and there is one element in the vector for each node in the selected node subset.

In various implementations, the selected node subset comprises one or more nodes of the one or more inner layers of the neural network. In such circumstances, computing the partial derivative of the secondary objective with respect to each node in the selected node subset may comprise computing a partial derivative of the primary objective with respect to an output activation of the node and/or an input to an activation function of the node.

In various implementations, the system further comprises a machine-learning learning coach, which select the one or more nodes that comprise the selected node subset and/or select the secondary objective. The machine-learning learning coach may select the nodes for the selected node subset and/or the secondary objective prior to the computations of the partial derivative of the secondary objective with respect to each node in the selected node subset of the plurality of nodes of the neural network.

In various implementations, the step of computing the activation value for each inner layer node comprises computing the activation value for each inner layer node using an activation function for each inner layer node. In one embodiment, the activation value for each inner layer node may be a function of one or more connection weights, and the step of updating the learned parameter may comprise updating the one or more connection weights for each inner layer node. In another embodiment, the activation value for each inner layer node is a function of a bias value, and the step of updating the learned parameter comprises updating the value for each inner layer node.

In various implementations, the method further comprises, prior to computing the activation value for each inner layer node, modifying, by the computer system, the activation function for one or more inner layer nodes of the neural network. The modifications to the activation functions may be in light of the secondary objective. For example, the modifications to the activation functions may smooth the activation function for the one or more inner layer nodes such that a large sudden change in the activation function as a function of its input values is spread out over a broader region of input values. Or the modifications to the activation functions may comprise modifying the activation function for the one or more inner layer nodes so that the derivation of the activation function for the one or more inner layer nodes is bounded away from zero.

The step of updating the learned parameter for the neural network may comprise updating the learned parameter using stochastic gradient descent. Also, the step of computing the partial derivative of the secondary objective with respect to each node in the selected node subset may comprise imposing an upper limit on the computed partial derivatives and/or limiting a number of layers of the neural network that a partial derivative of the secondary objective is propagated forward in the forward propagation of the partial derivatives through the neural network. The upper limit may be a factor r times a corresponding partial derivative of the primary objective.

In various implementations, the step of updating the learned parameter may comprise using a different learning rate for updating the learned parameter based on the computed partial derivatives for the primary objective than for updating the learned parameter based on the computed partial derivatives for the secondary objective. In particular, the learning rate for the secondary objective may be lower than the learning rate for the primary objective.

In various implementation, the method may further comprise the steps of: accumulating the partial derivatives for the primary objective over a first minibatch size of data training examples; and accumulating the partial derivatives for the secondary objectives over a second minibatch size of data training examples, wherein a size of the second minibatch does not equal a size of the first minibatch. The size of the second minibatch may be k times larger than the size of the first minibatch, where k is an integer greater than one.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A method for improving a neural network, wherein the neural network comprises:
an input layer comprising at least one input layer node;
an output layer comprising at least one output layer node; and
one or more inner layers between the input layer and the output layer, wherein each of the one or more inner layers comprise at least one inner layer node,
the method comprising:
for each of a plurality of training data examples:
in a feed forward computation through the neural network, computing, with a computer system, an activation value for each inner layer node of the neural network;
in a back-propagation computation through the neural network, computing, with the computer system, a partial derivative of a primary objective with respect to each inner layer node of the neural network; and
following the back-propagation computation, computing, with the computer system, a partial derivative of a secondary objective with respect to each node in a selected node subset of the neural network, wherein:
the selected node subset comprises one or more nodes of the neural network; and
the secondary objective is function of one or more computed partial derivatives of the primary objective computed in the back-propagation computation; and
the partial derivatives of the secondary objective for the selected node subset are computed using a forward-propagation through the neural network; and
updating, by the computer system, a learned parameter for the neural network based on, in part, the computed partial derivatives of the secondary objective.

2. The method of claim 1, wherein the neural network comprises two or more inner layers between the input layer and the output layer, and each of the two or more inner layers comprises at least one inner layer node.

3. The method of claim 2, wherein the neural network comprises a feedforward neural network.

4. The method of claim 1, wherein the primary objective is associated with a task selected from the group consisting of a classification task, a prediction task, a regression task, a pattern analysis task and a generation task.

5. The method of claim 1, wherein the secondary objective function is a function of the computed partial derivatives of the primary objective with respect to an activation value of each node of the selected node subset.

6. The method of claim 1, wherein:
the selected node subset comprises at least one input layer node;
the step of computing the partial derivative of the primary objective with respect to each node of the one or more inner layers in the neural network further comprises computing, with the computer system, a partial derivative of the primary objective with respect to activation values for the at least one input layer node in the selected node subset; and
the step of updating the learned parameter comprises updating, by the computer system, a learned parameter for the neural network based on, in part, the computed partial derivatives of the secondary objective with respect to the at least one input layer node in the selected node subset.

7. The method of claim 6, wherein the step of computing the partial derivative of the primary objective with respect to the activation values for the at least one input layer node in the selected node subset comprises assigning the at least one input layer node in the selected node subset an arbitrary bias value, wherein the arbitrary bias value is used in computing the partial derivative of the primary objective with respect to the activation values for the at least one input layer node in the selected node subset.

8. The method of claim 7, wherein the arbitrary bias value is zero.

9. The method of claim 6, wherein the secondary objective is a norm of a vector of partial derivatives of the primary objective, wherein there is one element in the vector for each node in the selected node subset.

10. The method of claim 9, wherein the norm comprises the L2 norm.

11. The method of claim 9, wherein the norm comprises the L1 norm.

12. The method of claim 1, wherein the selected node subset comprises one or more nodes of the one or more inner layers of the neural network.

13. The method of claim 12, wherein computing the partial derivative of the secondary objective with respect to each node in the selected node subset comprises computing a partial derivative of the primary objective with respect to an output activation of the node.

14. The method of claim 12, wherein computing the partial derivative of the secondary objective with respect to each node in the selected node subset comprises computing a partial derivative of the primary objective with respect to an input to an activation function of the node.

15. The method of claim 1, wherein the secondary objective is a norm of a vector of partial derivatives of the primary objective, wherein there is one element in the vector for each node in the selected node subset.

16. The method of claim 1, further comprising selecting, by a machine-learning learning coach, the one or more nodes that comprise the selected node subset.

17. The method of claim 1, further comprising, prior to computing the partial derivative of the secondary objective with respect to each node in the selected node subset of the plurality of nodes of the neural network, selecting, by a machine-learning learning coach, the one or more nodes that comprise selected node subset.

18. The method of claim 1, further comprising, prior to computing the partial derivative of the secondary objective with respect to each node in the selected node subset of the plurality of nodes of the neural network, selecting, by a machine-learning learning coach, the secondary objective.

19. The method of claim 1, further comprising, prior to computing the partial derivative of the secondary objective with respect to each node in the selected node subset of the plurality of nodes of the neural network, selecting, by a machine-learning learning coach, both the one or more nodes that comprise the selected node subset and the secondary objective.

20. The method of claim 1, wherein computing the activation value for each inner layer node comprises computing the activation value for each inner layer node using an activation function for each inner layer node.

21. The method of claim 20, wherein:
the activation value for each inner layer node is a function of one or more connection weights; and
updating the learned parameter comprises updating the one or more connection weights for each inner layer node.

22. The method of claim 20,
the activation value for each inner layer node is a function of a bias value; and
updating the learned parameter comprises updating the value for each inner layer node.

23. The method of claim 20, further comprising, prior to computing the activation value for each inner layer node, modifying, by the computer system, the activation function for one or more inner layer nodes of the neural network.

24. The method of claim 23, wherein modifying the activation function for one or more inner layer nodes of the neural network comprises modifying the activation function for the one or more inner layer nodes in light of the secondary objective.

25. The method of claim 24, wherein modifying the activation function for one or more inner layer nodes of the neural network comprises smoothing the activation function the one or more inner layer nodes such that a large sudden change in the activation function as a function of its input values is spread out over a broader region of input values.

26. The method of claim 23, wherein modifying the activation function for one or more inner layer nodes of the neural network comprises modifying the activation function for the one or more inner layer nodes so that the derivation of the activation function for the one or more inner layer nodes is bounded away from zero.

27. The method of claim 1, wherein updating the learned parameter for the neural network comprises updating the learned parameter using stochastic gradient descent.

28. The method of claim 1, wherein computing the partial derivative of the secondary objective with respect to each node in the selected node subset comprises imposing an upper limit on the computed partial derivatives.

29. The method of claim 1, wherein computing the partial derivative of the secondary objective with respect to each nodes in the selected node subset comprises limiting a number of layers of the neural network that a partial derivative of the secondary objective is propagated forward in the forward propagation of the partial derivatives through the neural network.

30. The method of claim 28, wherein the upper limit is a factor r times a corresponding partial derivative of the primary objective.

31. The method of claim 1, wherein updating the learned parameter comprises using a different learning rate for updating the learned parameter based on the computed partial derivatives for the primary objective than for updating the learned parameter based on the computed partial derivatives for the secondary objective.

32. The method of claim 31, wherein the learning rate for the secondary objective is lower than the learning rate for the primary objective.

33. The method of claim 1, further comprising:
accumulating the partial derivatives for the primary objective over a first minibatch size of data training examples; and
accumulating the partial derivatives for the secondary objective over a second minibatch size of data training examples, wherein a size of the second minibatch does not equal a size of the first minibatch.

34. The method of claim 33, wherein the size of the second minibatch is k times larger than the size of the first minibatch, where k is an integer greater than one.

35. The method of claim 34, wherein:
computing the partial derivative of the secondary objective with respect to each node in the selected node subset comprises imposing an upper limit on the computed partial derivatives; and
the upper limit is a factor r times a corresponding partial derivative of the primary objective.

36. A computer system for improving a neural network, wherein the neural network comprises:
an input layer comprising at least one input layer node;
an output layer comprising at least one output layer node; and
one or more inner layers between the input layer and the output layer, wherein each of the one or more inner layers comprise at least one inner layer node,
the computer system comprising one or more processing units that are programmed to:
for each of a plurality of training data examples:
in a feed forward computation through the neural network, compute an activation value for each inner layer node of the neural network;
in a back-propagation computation through the neural network, compute a partial derivative of a primary objective with respect to each inner layer node of the neural network; and
following the back-propagation computation, computing a partial derivative of a secondary objective with respect to each node in a selected node subset of the neural network, wherein:
the selected node subset comprises one or more nodes of the neural network; and
the secondary objective is function of one or more computed partial derivatives of the primary objective computed in the back-propagation computation; and
the partial derivatives of the secondary objective for the selected node subset are computed using a forward-propagation through the neural network; and
update a learned parameter for the neural network based on, in part, the computed partial derivatives of the secondary objective.

37. The computer system of claim 36, wherein the neural network comprises two or more inner layers between the input layer and the output layer, and each of the two or more inner layers comprises at least one inner layer node.

38. The computer system of claim 37, wherein the neural network comprises a feedforward neural network.

39. The computer system of claim 36, wherein the secondary objective function is a function of the computed partial derivatives of the primary objective with respect to an activation value of each node of the selected node subset.

40. The computer system of claim 36, wherein:
the selected node subset comprises at least one input layer node; and
the one or more processing units are programmed to:
compute a partial derivative of the primary objective with respect to activation values for the at least one input layer node in the selected node subset; and
update a learned parameter for the neural network based on, in part, the computed partial derivatives of the secondary objective with respect to the at least one input layer node in the selected node subset.

41. The computer system of claim 40, wherein the one or more processors are programmed to compute the partial derivative of the primary objective with respect to the activation values for the at least one input layer node in the selected node subset by assigning the at least one input layer node in the selected node subset an arbitrary bias value, wherein the arbitrary bias value is used in computing the partial derivative of the primary objective with respect to the activation values for the at least one input layer node in the selected node subset.

42. The computer system of claim 40, wherein the secondary objective is a norm of a vector of partial derivatives of the primary objective, wherein there is one element in the vector for each node in the selected node subset.

43. The computer system of claim 42, wherein the norm comprises the L2 norm.

44. The computer system of claim 42, wherein the norm comprises the L1 norm.

45. The computer system of claim 36, wherein the selected node subset comprises one or more nodes of the one or more inner layers of the neural network.

46. The computer system of claim 45, wherein the one or more processing units are programmed to compute that partial derivative of the secondary objective with respect to each node in the selected node subset by computing a partial derivative of the primary objective with respect to an output activation of the node.

47. The computer system of claim 45, wherein the one or more processing units are programmed to compute the partial derivative of the secondary objective with respect to each node in the selected node subset by computing a partial derivative of the primary objective with respect to an input to an activation function of the node.

48. The computer system of claim 36, wherein the secondary objective is a norm of a vector of partial derivatives of the primary objective, wherein there is one element in the vector for each node in the selected node subset.

49. The computer system of claim 36, further comprising a learning coach computer system for determining the one or more nodes that comprise the selected node subset.

50. The computer system of claim 36, further comprising a machine-learning learning coach for, prior to computing the partial derivative of the secondary objective with respect to each node in the selected node subset of the plurality of nodes of the neural network, selecting the one or more nodes that comprise selected node subset.

51. The computer system of claim 36, further comprising a machine-learning learning coach for, prior to computing the partial derivative of the secondary objective with respect to each node in the selected node subset of the plurality of nodes of the neural network, selecting the secondary objective.

52. The computer system of claim 36, further comprising, a machine-learning learning coach for, prior to computing the partial derivative of the secondary objective with respect to each node in the selected node subset of the plurality of nodes of the neural network, selecting both the one or more nodes that comprise the selected node subset and the secondary objective.

53. The computer system of claim 36, wherein the one or more processing units are programmed to compute the activation value for each inner layer node by computing the activation value for each inner layer node using an activation function for each inner layer node.

54. The computer system of claim 53, wherein:
the activation value for each inner layer node is a function of one or more connection weights; and
the one or more processing units are programmed to update the learned parameter by updating the one or more connection weights for each inner layer node.

55. The computer system of claim 53, wherein:
the activation value for each inner layer node is a function of a bias value; and
the one or more processing units are programmed to update the learned parameter by updating the value for each inner layer node.

56. The computer system of claim 53, wherein the one or more processing units are further programmed to, prior to computing the activation value for each inner layer node, modifying the activation function for one or more inner layer nodes of the neural network.

57. The computer system of claim 56, wherein the one or more processing units are further programmed to modify the activation function for one or more inner layer nodes of the neural network by modifying the activation function for the one or more inner layer nodes in light of the secondary objective.

58. The computer system of claim 57, wherein the one or more processing units are further programmed to modify the activation function for one or more inner layer nodes of the neural network by smoothing the activation function the one or more inner layer nodes such that a large sudden change in the activation function as a function of its input values is spread out over a broader region of input values.

59. The computer system of claim 56, wherein the one or more processing units are further programmed to modify the activation function for one or more inner layer nodes of the neural network comprises modifying the activation function for the one or more inner layer nodes so that the derivation of the activation function for the one or more inner layer nodes is bounded away from zero.

60. The computer system of claim 36, wherein the one or more processing units are further programmed to update the learned parameter for the neural network by updating the learned parameter using stochastic gradient descent.

61. The computer system of claim 36, wherein the one or more processing units are further programmed to compute the partial derivative of the secondary objective with respect to each node in the selected node subset by imposing an upper limit on the computed partial derivatives.

62. The computer system of claim 36, wherein the one or more processing units are further programmed to compute the partial derivative of the secondary objective with respect to each nodes in the selected node subset by limiting a number of layers of the neural network that a partial derivative of the secondary objective is propagated forward in the forward propagation of the partial derivatives through the neural network.

63. The computer system of claim 61, wherein the upper limit is a factor r times a corresponding partial derivative of the primary objective.

64. The computer system of claim 36, wherein the one or more processing units are further programmed to update the learned parameter by using a different learning rate for updating the learned parameter based on the computed partial derivatives for the primary objective than for updating the learned parameter based on the computed partial derivatives for the secondary objective.

65. The computer system of claim 64, wherein the learning rate for the secondary objective is lower than the learning rate for the primary objective.

66. The computer system of claim 36, wherein the one or more processing units are further programmed to:
accumulate the partial derivatives for the primary objective over a first minibatch size of data training examples; and
accumulate the partial derivatives for the secondary objective over a second minibatch size of data training examples, wherein a size of the second minibatch does not equal a size of the first minibatch.

67. The computer system of claim 66, wherein the size of the second minibatch is k times larger than the size of the first minibatch, where k is an integer greater than one.

68. The computer system of claim 67, wherein:
wherein the one or more processing units are further programmed to compute the partial derivative of the secondary objective with respect to each node in the selected node subset by imposing an upper limit on the computed partial derivatives; and
the upper limit is a factor r times a corresponding partial derivative of the primary objective.
